(19) United States
(12) Patent Application Publication
(10) Pub. No.: US 2026/0364861 A1
(43) Pub. Date: Nov. 19, 2026

(54) METHOD AND PRESS FOR PRODUCINE A SLANTED PANEL

(71) Applicant: ROBOR SRL, Quinto di Treviso (IT)

(72) Inventor: Simone BORSATO, Quinto di Treviso (IT)

(21) Appl. No.: 19/486,978

(22) PCT Filed: May 24, 2023
(86) PCT No.: PCT/IB2023/055329

§ 371 Date: Nov. 24, 2025

(51) Int. Cl. B29C 44/58; B29C 44/14; B29K 75/00; B29K 105/04; B29K 705/02

(52) U.S. Cl. CPC B29C 44/585; B29C 44/14; B29K 2075/00; B29K 2105/04; B29K 2705/02

(57) ABSTRACT

A method for in-line production of panels consisting of an outer shell filled with an insulating material is described, in which while inserting the insulation material the panel is made to slide between two facing surfaces of a press which are opposite to each other,
wherein at least one of the surfaces is inclined with respect to the other surface about an axis parallel to the panel's sliding direction.

### TECHNICAL FIELD

The invention relates to a method and press for producing panels, e.g. for in-line producing panels.

### BACKGROUND

Plants are known to produce panels formed of two outer metal sheets and an inner layer of insulation material, see e.g. WO 2010/029587. Although production lines allow very large panels (up to 25 m in length) to be manufactured, the panels are almost always flat. Some plants allow producing panels with opposite major faces that are inclined by an angle, but to do so counter-frames (sort of wedges) are mounted inside the press to create a sloping surface. The obvious disadvantage of the system is that it is necessary to adapt the size and shape of the wedge to each size of panel produced, a manual operation that is very labor-intensive, time-consuming and sometimes impractical.

### SUMMARY

Proposing an alternative production method is the main object of the invention, which is defined in the attached claims, in which the dependent ones define advantageous variants.

A method is proposed for producing a panel formed of an outer shell, which for example consists of two metal sheets connected to each other, filled with an insulating material,
Wherein, while inserting the insulation material, the panel, e.g. the two metal sheets, is/are made to slide between two facing surfaces of a press which are opposite each other,
wherein at least one of the surfaces is inclined with respect to the other surface about an axis parallel to the sliding direction of the panel.

This solves the problem of the inconvenient wedges to be placed in the press by getting rid of them.

In a preferred variation, one of the surfaces is parallel to a horizontal plane and the other is inclined relative to the other surface.

In a preferred variant, the inclination of at least one of the two press surfaces is adjusted to adapt the press to the production of a panel that has one side tilted with respect to an opposite side thereof as much as the inclination between the two press surfaces.

In a preferred variation, the insulating material is fluid and is injected into the shell as the latter passes through the press.

In a preferred variation, the insulation material is synthetic or plastic foam, e.g. polyurethane, or rock wool.

Preferably the panel is produced in-line with continuity.

Preferably the panel is formed of:
(i) externally: two outer metal sheets made from a continuous sheet of sheet-metal or one or more flexible supports coupled together (e.g. a sheet obtained from aluminum or fiberglass coils), or
one or more rigid plates coupled together (e.g. of wood or plasterboard or marble or ceramic or cardboard or other); and
(ii) internally: an insulating layer, placed between the sheets or the plates or the supports.

Another aspect of the invention relates to a press for pressing, e.g. in-line pressing, a panel (e.g. made like the panel defined above), comprising:
an upper pressing surface and a lower pressing surface between which to slide and press two opposite sides of the panel,
wherein at least one of said surfaces can be tilted with respect to the other surface about an axis parallel to the sliding direction of the panel inside the press.

In a preferred variant, one of the surfaces, e.g. the lower surface, is fixed and/or parallel to a horizontal plane, and the other surface is tiltable relative to the former. Thus it is mechanically easier to move the upper surface stably and with more freedom of movement.

In a preferred variation, the two surfaces are mounted on means for relatively moving at least one of the two surfaces in order to adjust the inclination of at least one of the two surfaces relative to the other surface.

In a preferred embodiment of said means, the press comprises:
a lower frame incorporating the lower surface,
an upper frame which incorporates the upper surface and which at its side ends is hinged to two supports about two respective axes parallel to each other and parallel to the direction of the panel's advancement inside the press,
an actuator, e.g. mounted between the lower frame and a support, for moving relatively, preferably linearly, one or each support relative to the lower frame. Thus the press manages to independently adjust the height of one or each support relative to the lower frame with the ultimate effect of varying the tilt of the upper frame (and thus of the upper pressing surface).

In a variation one or each of said surfaces (e.g. one or each of surfaces 30, 40 described below) consists of a row of flat, sliding plates that all lie on the same plane to form said surface. This facilitates the movement of the panel inside the press. In a more preferred variation, the row of plates is comprises in a closed circuit (ring) of sliding plates that form a movable transport surface for the panel on one side of the circuit or ring. In particular, in the row of flat plates the plates are spaced apart in the direction of the plate advancement (which is the same direction as the panel feed).

### BRIEF DESCRIPTION OF THE DRAWINGS

The advantages of the invention will be clearer from the following description of a preferred embodiment of device and method, reference making to the attached drawing wherein

FIG. 1 shows schematically an enlarged section of a panel obtainable by the method of the invention;

FIG. 2 shows a front view of a press according to the invention.

### DETAILED DESCRIPTION

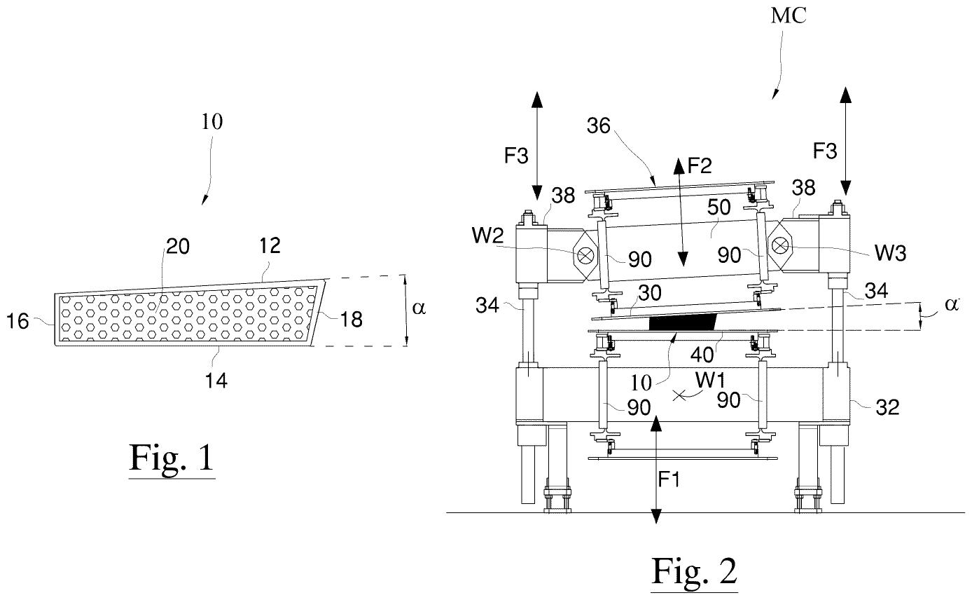

FIG. 1 shows in cross-section a panel 10 having two opposite major sides 12, 14 and two sides 16, 18 relative to the thickness. The cross-section is taken in a plane orthogonal to the length of the panel (orthogonal to the drawings sheet).

The sides 12, 14, 16, 18 delimit a cavity, which in particular is filled with an insulating material 20, e.g. polyurethane foam. In particular, the panel 10 is formed of an outer shell consisting of two metal sheets attached to each other.

The sides 12, 14 lie on geometric planes that form an angle 0<α<90 degrees.

When the panel 10 is laid in place on an architectural element (e.g. a building façade) and rests on the side 12, the side 14 remains unobstructed and can create reflected light effects and/or break the monotony of a large surface, especially if a row of adjacent panels 10 is installed. The effect is even more pronounced if the panels 10 in the row each have a different α angle.

A press MC can be used to produce the panel 10 as in FIG. 2.

In a known manner, the panel 10, while the insulation material 20 is inserted, slides between two facing and opposite surfaces 30, 40 of the press MC, which serve to hold the plates 12, 14 in place. E.g. one or each of the two surfaces 30, 40 may be a known plate-chain platform used in this type of press.

At least one of the surfaces 30, 40 is inclined and tiltable by the angle a (the same as the panel 10), relative to the other surface, about an axis W1 parallel to the sliding direction of the panel 10. The W1 axis is orthogonal to the plane of the figure in the drawing.

The press MC is configured to allow adjustment of the α angle by independently varying the inclination of at least one of the two surfaces 30, 40. In a preferred variation, the lower surface 40 is parallel to a horizontal plane and the upper surface 30 is tilted with respect to the former by the angle α.

FIG. 2 illustrates preferred means of achieving said adjustable tilt (adjustable α).

For simplicity's sake, the bottom surface 40 is fixed, or at least is at a fixed angle and preferably can only be moved vertically (arrow F1) by drives 90, e.g. hydraulic pistons.

The bottom surface 40 is mounted on a fixed frame 32 to which two extensible columns 34 supporting a movable frame 36 are attached. The two extensible columns 34 are e.g. hydraulic pistons or electric linear drives, e.g. recirculating ball drives.

The movable frame 36 comprises two lateral beams or supports 38 to which the opposite ends of a central platform 50 are hinged. The two hinging axes W2, W3 are parallel to the W1 axis.

On the bottom of the central platform 50 is mounted the upper surface 30, which preferably can also be moved linearly (arrow F2) by drives 90, e.g. hydraulic pistons, relative to the central platform 50.

Since the side beams 38 can be raised relative to the fixed frame 32 (see arrow F3) by as much as desired, in the press MC it is possible not only to determine the distance between the surfaces 30, 40 but also the inclination of the center platform 50 relative to the fixed frame 32. If the side beams 38 are raised equally with respect to the fixed frame 32, the surfaces 30, 40 are parallel (α=0). Conversely, if the side beams 38 are raised relative to the fixed frame 32 by a different amount, the surfaces 30, 40 become inclined to each other (α>0).

In this way the pressing surfaces the press MC can be adjusted to the inclination between the sides 12, 14 of the panel 10.

In the press MC there are means for compensating the increasing distance between the axes W2, W3 when the center platform 50 rotates (i.e., when α increases). For example, the supports of axes the W2, W3 may be made of elastic material, or the axes W2, W3 are movable horizontally relative to the beams 38 and/or the platform 50.

In general, the platform 50 may be rotated by moving the axes W1 or W3 with any known mechanical technique.

In a variation, only one of the axes W2 or W3 may be implemented in the press, and/or only one drive 34 may be used. In general, the platform 50 may be rotated about the only axis W1 or W3 by any known mechanical technique.

In a variation, an inclination on the other side from that shown may be implemented in the press.

In a variation, the angle α may be implemented in the press by swinging one or each of the two surfaces 30, 40 about a different axis that is parallel to the axis W1 and placed approximately in the middle of the two surfaces 30, 40. For example, this different axis is placed at the midpoint between axes W2, W3 in FIG. 2.

1. Method for producing a panel formed of an outer shell filled with an insulating material,
wherein, while inserting the insulation material, the panel is made to slide between two facing surfaces of a press which are opposite to each other,
wherein at least one of the surfaces is inclined with respect to the other surface about an axis parallel to the sliding direction of the panel.

2. Method according to claim 1, wherein one of the surfaces is parallel to a horizontal plane and the other is inclined relative to the other surface.

3. Method according to claim 1, wherein the inclination of at least one of the two surfaces of the press is adjusted to adapt the press to produce a panel having one side inclined relative to an opposite side thereof as much as the inclination between the two surfaces of the press.

4. Method according to claim 1, wherein the insulating material is fluid and is injected into the shell as the shell passes through the press.

5. Method according to claim 1, wherein the panel is formed externally of two outer sheets made from a continuous sheet of sheet-metal, and internally of an insulating layer placed between the sheets.

6. Press for in-line pressing a panel comprising:
an upper pressing surface and a lower pressing surface between which to slide and press two opposite sides of the panel,
wherein at least one of said surfaces is inclinable with respect to the other surface about an axis parallel to the sliding direction of the panel inside the press.

7. Press according to claim 6, wherein one of the surfaces, e.g. the lower surface, is fixed and/or parallel to a horizontal plane and the other surface is tiltable relative to the other surface.

8. Press according to claim 6, wherein the two surfaces are mounted on means for relatively moving at least one of the two surfaces to adjust the inclination of at least one of the two surfaces relative to the other surface.

9. Press according to claim 6, comprising:
a lower frame incorporating the lower surface,
an upper frame which incorporates the upper surface and which at its side ends is hinged to two supports about two respective axes parallel to each other and parallel to the sliding direction of the panel inside the press,
an actuator for relatively moving one or each support relative to the lower frame.

10. Press according to claim 6, wherein one or each of said surfaces comprises a row of flat, sliding plates all lying in the same plane to form said surface.

11. Method according to claim 2, wherein the inclination of at least one of the two surfaces of the press is adjusted to adapt the press to produce a panel having one side inclined relative to an opposite side thereof as much as the inclination between the two surfaces of the press.

12. Press according to claim 7, wherein the two surfaces are mounted on means for relatively moving at least one of the two surfaces to adjust the inclination of at least one of the two surfaces relative to the other surface.

13. Press according to claim 7, comprising:
a lower frame incorporating the lower surface,
an upper frame which incorporates the upper surface and which at its side ends is hinged to two supports about two respective axes parallel to each other and parallel to the sliding direction of the panel inside the press,
an actuator for relatively moving one or each support relative to the lower frame.

14. Press according to claim 8, comprising:
a lower frame incorporating the lower surface,
an upper frame which incorporates the upper surface and which at its side ends is hinged to two supports about two respective axes parallel to each other and parallel to the sliding direction of the panel inside the press,
an actuator for relatively moving one or each support relative to the lower frame.

15. Press according to claim 12, comprising:
a lower frame incorporating the lower surface,
an upper frame which incorporates the upper surface and which at its side ends is hinged to two supports about two respective axes parallel to each other and parallel to the sliding direction of the panel inside the press,
an actuator for relatively moving one or each support relative to the lower frame.

16. Press according to claim 7, wherein one or each of said surfaces comprises a row of flat, sliding plates all lying in the same plane to form said surface.

17. Press according to claim 8, wherein one or each of said surfaces comprises a row of flat, sliding plates all lying in the same plane to form said surface.

18. Press according to claim 12, wherein one or each of said surfaces comprises a row of flat, sliding plates all lying in the same plane to form said surface.

19. Press according to claim 9, wherein one or each of said surfaces comprises a row of flat, sliding plates all lying in the same plane to form said surface.

20. Press according to claim 13, wherein one or each of said surfaces comprises a row of flat, sliding plates all lying in the same plane to form said surface.
